(19) United States
(12) Patent Application Publication
(10) Pub. No.: US 2003/0101700 A1
(43) Pub. Date: Jun. 5, 2003

(54) Means of, and apparatus for, rapidly converting homes or other common structures into safe areas during biological or chemical attack

(76) Inventors: Robert Van Burdine, Ardmore, TN (US); Dorothy Devine Burdine, Ardmore, TN (US)

Correspondence Address: Robert Van Burdine, 600 Rolin Hollow Road, Ardmore, TN, 38449, US

(21) Appl. No.: 10/007,394

(22) Filed: Dec. 5, 2001

(51) Int. Cl. B01D 46/00

(52) U.S. Cl. 55/385.2; 95/273; 454/187

(57) ABSTRACT

A common structure, such as a home or other building, equipped with an apparatus, comprised of a positive pressure ventilator and a decontaminator device, can be immediately converted into a safe area for human inhabitants, machines, and materials, against chemical or biological attack. The apparatus takes in outside contaminated air, destroys and/or removes the biological or chemical agent, renders the air breathable, and forces the now decontaminated air into the structure. The structure is slightly pressurized with decontaminated air, causing positive and continuous outflow preventing contaminated air from entering the structure. The invention includes the apparatus, the method of positive pressure for preventing the entry of harmful agents, and kits and methods for further rendering a conventional structure into a safe area.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

The present invention is related generally to structure heating, ventilating, and air conditioning. More specifically, the present invention is related to apparatus and methods for providing an environment within a common structure capable of protecting humans, other living things, supplies, equipment and storage items from exposure to harmful airborne chemical and/or biological agent attack.

Terrorist attacks have increased in frequency and severity in the wake created by the demise of the cold war and decline in super-power tensions. Technical advances in the field of chemical and biological (CB) weapons, and the wide distribution and rumored lax control of these weapons has resulted in the recognition of the distinct possibility that these weapons of mass destruction could be used by relatively small terrorist organizations against there perceived enemies. While it is still possible for nations to use CB weapons during a war situation, these activities are usually directed against warring forces and only on occasion against the civilian population. Terrorists are usually interested in committing acts that tend to cause a nation or organization to defend itself in a manner often inconsistent with the rights and privileges of its citizens or economic functions, with the resulting inefficiencies often causing the greater harm to the perceived enemy. These attacks are usually carried out against easy targets such as embassies, ships, aircraft, government, business and civilian populations.

CB weapons can be easily transported and delivered against such targets often by a single individual or small group. The fact that an attack has occurred may not become evident until the victims are already ill and possibly beyond medical help.

CB weapons include chemical agents such as chlorine and mustard gas, nerve agents such as VX, and biological agents such as smallpox and anthrax.

CB weapon agents may be delivered by simply dispersing them in the air, such as by crop dusting aircraft, or by simply dropping them from a great height in a wind, such as out of a skyscraper or from a mountain top, in order to disperse the agent over a large area and affect a number of people, or prevent the use of the affected area by people. A large structure, such as an office building, may be attacked by introducing the agent into an HVAC duct system or by simply dispersing the agent into the work areas.

Structures such as homes, shopping and other public buildings are commonly designed to allow the penetration of outside air, limiting the air exchange only in regards to the economies of HVAC and heating costs. These structures are especially susceptible to airborne CB agent attack, and are very difficult to adequately seal against outside air penetration even if the need is urgent and some lead-time is available.

It is desirable to protect these structures from CB attack without substantial remodeling and rebuilding, both on a continuous basis during times of warning and during an actual attack which may come without any warning, and may not be detected for some time. It is also desirable to be able to immediately convert these common structures a safe area free of CB agents during an attack.

Numerous technologies have been developed to protect and individual for a limited time such as gas masks and biological and chemical protection suits. Enclosure technologies such as shelters have been developed that require a specially designed and sealed area that is supplied with its own internal oxygen supply or a special filter and blower thereby sealing out the harmful agents. These techniques all have the disadvantage of offering protection for a very limited time in a very limited area and only after a situation such as an attack is known to have occurred. If an attack is initiated during the night when people are asleep in their homes, it is unlikely that many could be alerted in time to enter their shelters before they are infected or poisoned. The apparatus and method herein described provides a substantial level of continuous protection without any action on the part of the persons being attacked. The apparatus, in combination with the additional sealing methods herein described, offers extended protection superior to all other means known in that it allows persons the use of their residence and all its facilities.

### BRIEF SUMMARY OF THE INVENTION

It is an object of the present invention to provide an apparatus facilitated for the taking in of outside air that is contaminated with harmful CB agents, destroying and rendering harmless those CB agents, and using the decontaminated air to provide positive pressurize in a common structure, causing a positive airflow from the inside to the outside thereby making it improbable that an airborne CB agent could infiltrate the structure. It is also an object of the present invention to provide a kit for the additional sealing of such things as windows and doors in common structures, allowing the outflow in areas not readily sealable such as under walls, behind cabinets, and around ceiling light fixtures to increase and thereby provide more robust rejection of the CB agent contaminated air.

The present invention offers numerous improvements over any prior art or known methods in the resistance to and survival of a biological and/or chemical attack. The present invention affords the ability to maintain a continuous clean air supply flowing into a common and unmodified structure such as a home, providing a continuous positive pressure thereby eliminating the possibility of a biological or biochemical attack having any impact on the contents of the structure, human or otherwise. The present invention further offers the ability to create this safe environment in a common structure and to maintain this environment for extended periods. The present invention also provides for the maintenance of a typical and comfortable atmosphere being maintained in a common structure unlike any prior art. Additional sealing and modification methods are a preferred embodiment of the present invention that further provide for the rapid sealing of a common structure to provide even greater resistance to extended biological and biochemical attack.

### BRIEF DESCRIPTION OF THE SEVERAL VIEWS OF THE DRAWING

The present invention will be more clearly understood from the following description in conjunction with the accompanying drawings, where:

FIG. 1 is a highly diagrammatic perspective view of a common structure detailing the use of the apparatus to pressurize the structure with decontaminated air and prevent the infiltration and penetration of contaminated air containing CB agents.

FIG. 2 is a cross section of the apparatus detailing a typical folded process design with contaminated air intake through outside air dust filter 13 and clean air exhaust into the safe structure through grill 25.

FIG. 3 is a highly diagrammatic, perspective, cutaway view of one embodiment of the apparatus.

FIG. 4 is a highly diagrammatic view of another embodiment of the apparatus demonstrating the folding of the air path for packaging.

### DETAILED DESCRIPTION OF THE INVENTION

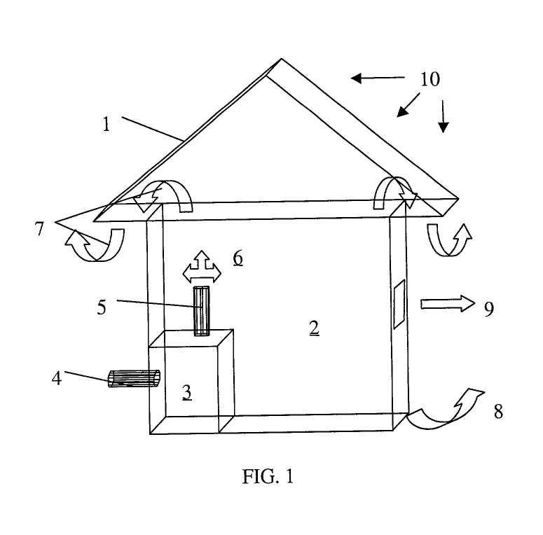

The principal and method of the present invention may be clearly understood by referencing FIG. 1. FIG. 1 illustrates a common structure 1, such as a residential dwelling, enclosing an atmosphere and area volume 2. Outside air 10 containing CB agents is taken into apparatus 3 through duct 4 as connected and exposed to the outside air 10, decontaminated and exhausted into volume 2 by blower and exhaust port 5. The decontaminated air 6 provides additional volume to volume 2 thereby generating and causing an overpressure which escapes and causes positive outward flow 7 through openings in the ceiling, outward flow 8 through openings in the floor, and outward flow 9 through openings in the walls including doors, windows and other openings such as wall plugs and such as may be intentional or non-intentional.

It is a preferred embodiment of the present invention that this positive outflow of decontaminated air protects the volume 2 from contamination and renders the area and volume of the structure safe from CB agents as may be contained in the outside air 10.

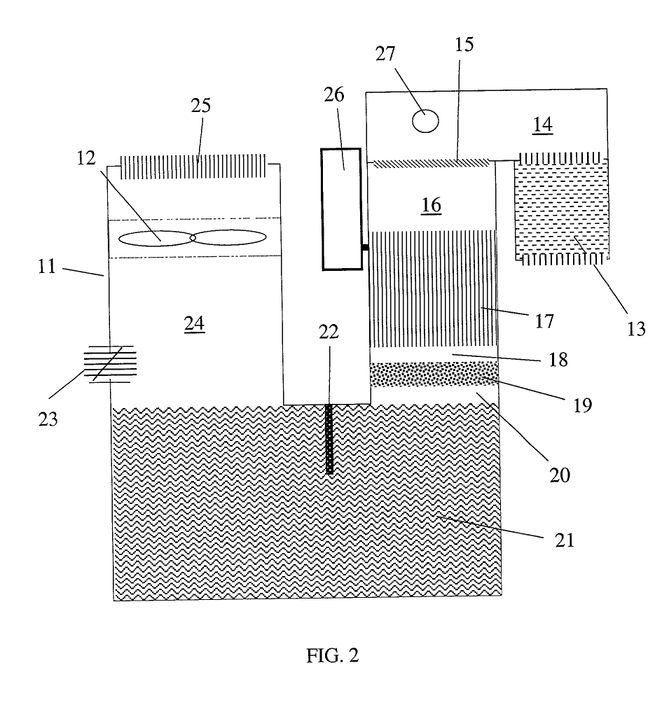

The principal and apparatus may be more fully understood by referencing FIG. 2. FIG. 2 illustrates a cross section view of a typical folded and compact version of the apparatus. The shell of the apparatus 11 provides a reasonably air tight enclosure for the ducting of contaminated air through intake air filter 13 and being exhausted into the safe area and volume of the structure through decontaminated air outlet 25.

It is a preferred embodiment of the present invention that in the case of the apparatus being totally contained within the safe volume and area, the shell 11 contains a volume which is maintained under reduced pressure by the action of the air impeller 12 thereby negating any requirement for shell 11 to be air tight and still maintaining assurance that all CB laden air will be completely ducted through the apparatus without chance of CB agent leaking or being expelled into the safe volume and area.

It is a preferred embodiment of the present invention that in the case where the apparatus is located totally outside the safe area and volume, the air impeller 12 is located before the dust and large particle filter 13 in order to pressurize the shell 11 assuring that no CB agent containing air is drawn into the apparatus at any point other than at the beginning of the decontamination process.

In FIG. 2, contaminated air is first taken into dust and large particulate filter 13 and passes directly into air space 14. The air and its load of CB agent is exposed to hard ultraviolet (UV) radiation in the 400 nanometer and lower range of wavelength from the UV producing bulb 27. The time the air requires to pass through the air space and volume 14 is calculated and provided for the destruction of most active biological agents. Certain chemical agents are also destroyed or deactivated by exposure to the UV light. The air now passes through a High Efficiency Particulate Air (HEPA) filter 15, which captures particles down to the fractional micron size. This is sufficient to capture spores such as those typically presented by the biological agent form of Anthrax (1 to 10 microns in diameter) and other sporeing biological agents. This is also sufficient to capture certain forms of mold, plasmids, and other larger biological agents as will be known to those skilled in the art of biological weapons.

It is a preferred embodiment of the present invention that the biological and also larger chemical agents, such as crystals, captured by the HEPA filter 15 are now exposed to the UV light from UV bulb 27 for an extended period of time, thereby more effectively destroying them.

The residuals of the decomposed CB agents and the agents too small to be captured by the HEPA filters 15 now pass into the air space 16.

It is a preferred embodiment of the present invention that the air space 16 allows the uniform and consistent entry of the air and the CB agents and residuals into the electric plasma device 17.

This device generates a cold and hot corona through the generation of an air electrical plasma. High voltage electrical energy is supplied by power supply 26. This produces a condition of intense UV light below 400 nanometers in wavelength, and generally centered in the 350-nanometer wavelength range, being well adapted to the destruction of all known biological agents and many biochemical warfare agents as well. The electric plasma device further produces highly concentrated ozone gas, which is a strong oxidizing agent and is known to be effective in the destruction of many biological and chemical agents. The electric plasma device also produces large amounts of nitrous oxides, which are strong agents in the breakdown and destruction of chemical and biological agents. The electrical plasma will destroy, by oxidation and reduction, all of the known biological and chemical agents.

This combination of actions result in the complete and total destruction of all known biological and biochemical agents. The air with its load of destructed CB agents now enters air space 18, which provides for the uniform and consistent entry of the air into ozone and nitrous oxide destructor 19. As nitrous oxide and ozone are not suitable for breathing in a concentrated form, the destructor 19 reduces these agents formed by the electric plasma device 17 into carbon dioxide, nitrogen gas, and water through catalytic action. The air stream now enters air space 20, which allows for the uniform and consistent entry of the air and its chemical load into chemical bed 21.

The chemical bed 21 is constituted of filter materials and chemicals such as activated carbon that are typical of military gas masks. The chemical bed 21 may also contain calcium carbonate, marble and limestone. The chemical bed 21 removes and adsorbs all remaining harmful agents as may be remaining and renders the air into a normal condition that is breathable and safe for typical habitat and storage type atmospheres. Deflector restriction 22 assures that all the air is passed through the chemical bed 21 material and that none of the air can escape around the chemicals and enter the interior and safe air space and volume in an untreated and harmful condition.

It is a preferred embodiment of the present invention that the deflector restrictions such as 22 assure that all the contaminated air is passed through the chemical bed and processes and that none of the air can escape around these areas without fully interacting, such as along the wall, and enter the interior and safe air space and volume in an untreated and harmful condition.

The air now enters air space 24. Air space 24 is pressure regulated by bypass air valve 23 to control the overpressure of the interior space and volume 2 as noted in FIG. 1. Bypass valve 23 regulates the amount of inside safe air allowed into air space 24 thereby regulating the draw pressure on shell 11 and the treatment mechanisms contained therein. Bypass valve 23 may be made more closed thereby increasing the amount of outside air drawn in and treated, thereby raising the volume and overpressure of the inside of the structure. Bypass valve 23 may also be made more open, taking in safe air from the inside of the structure and reducing the amount of outside air taken in and thereby reducing the overpressure of the inside of the structure.

It is a preferred embodiment of the present invention that the amount of air decontaminated by the apparatus and taken into the structure be regulated such that the structure remains positively pressurized.

Air impeller 12 causes airflow through the apparatus and may be of a plurality of types including fans and blowers, or pistons or other methods such as ventures or other methods and devices as may be conceived to produce airflow through the apparatus. Decontaminated air is discharged into the save area and volume through air outlet 25. Air outlet 25 may be constituted of a plurality of openings including grills, vents, pipes, ducts or other means of air conveyance.

FIG. 3 illustrates another embodiment of the invention where the apparatus is enlarged to provide substantially more decontaminated air in order protect a larger structure. FIG. 3 illustrates a perspective view of a linear and segmented version of the apparatus. The shell of the apparatus 45 provides a reasonably air tight enclosure for the ducting of contaminated air through contaminated air intake 27 which is connected to the outside air by a standard HVAC duct (not shown), and being exhausted into the safe area and volume of the structure through decontaminated air outlet 44.

In the case of the apparatus being totally contained within the safe volume and area, the shell 45 contains a volume which is maintained under reduced pressure by the action of the air impeller, made up of air impellers 39 and 43, thereby negating any requirement for shell 45 to be air tight and still maintaining assurance that all CB laden air will be completely ducted through the apparatus without chance of CB agent leaking or being expelled into the safe volume and area.

In the case where the apparatus is located totally outside the safe area and volume, the air impeller, made up of air impellers 39 and 43, is located before the contaminated air intake 27 in order to pressurize the shell 45 assuring that no CB agent containing air is drawn into the apparatus at any point other than the beginning of the decontamination process.

It is a preferred embodiment of the present invention that the shell or enclosure of the apparatus of the present invention not be required to be air tight in order to provide correct, safe and adequate intake, ducting, and decontaminating of the contaminated air.

Contaminated air is first taken into contaminated air intake 27 and passes directly into air space 29. The air and its load of CB agent is exposed to hard ultraviolet (UV) radiation in the 400 nanometer or lower range of wavelength from the UV producing bulbs 28. The time the air requires to pass through the air space and volume 29 is calculated to provide for the destruction of most active biological agents. Certain chemical agents are also destroyed or deactivated by exposure to the UV light. The air now passes through a HEPA filter 30, which captures particles down to the fractional micron size. This is sufficient to capture spores such as those typically presented by the biological agent form of Anthrax (1 to 10 microns in diameter) and other sporeing biological agents. This is also sufficient to capture certain forms of mold, plasmids, and other larger biological agents as will be known to those skilled in the art of biological weapons. The biological and also larger chemical agents, such as crystals, captured by the HEPA filter 30 are now exposed to the UV light from UV bulbs 28 for an extended period of time thereby more effectively destroying them.

It is a preferred embodiment of the present invention that the HEPA filter is canted to provide more surface area thereby reducing the airflow velocity through the filter and increasing its ability to capture particulate.

The residuals of the decomposed CB agents, and the agents too small to be captured by the HEPA filter 30, now pass into the air space 31. The air space 31 allows the uniform and consistent entry of the air and the CB agents and residuals into the electric plasma device 32. This device generates a cold and hot corona through the generation of an air electrical plasma. This produces a condition of intense UV light centered in the 350-nanometer wavelength range and well adapted to the destruction of all known biological and many biochemical agents. The electric plasma device further produces highly concentrated ozone gas, which is a strong oxidizing agent and is known to be effective in the destruction of many biological and chemical agents. The electric plasma device also produces large amounts of nitrous oxides, which are strong agents in the breakdown, and destruction of chemical and biological agents. The electrical plasma will destroy by oxidation and reduction most of the known biological and chemical agents. This combination of actions result in the complete and total destruction of all known biological and complex chemical agents.

The air with its load of destructed CB agents now enters air space 33, which provides for the uniform and consistent entry of the air into ozone and nitrous oxide destructor 34. As nitrous oxide and ozone are not suitable for breathing in a concentrated form, the destructor 34 reduces these agents formed by the electric plasma device 32 into carbon dioxide, nitrogen gas, and water through catalytic action. The air stream now enters air space 35, which allows for the uniform and consistent entry of the air and its chemical load into chemical bed adsorbed 36. The chemical bed adsorbed 36 is constituted of filter materials and chemicals such as activated carbon that are typical of military gas masks. The chemical bed 36 may also contains limestone. The chemical bed 36 removes and adsorbs all remaining harmful agents as may be remaining and renders the air into a normal condition that is breathable and safe for typical habitat and storage type atmospheres.

The air then passes into airspace 37, which allows for the uniform and consistent entry into activated carbon bed 38. Activated carbon bed 38 assures that the air stream is not only breathable, but provides assurance that all unpleasant odors and other disagreeable smell and chemicals are completely removed from the air stream. This provides for a complete comfort level not obtained with any prior art and is a preferred embodiment of the invention.

The air now passes into airspace 40 where it is propelled by air impeller 39 into air space 42. Air spaces 40 and 42 are divided and made separate by wall 41. The air is then propelled by air impeller 43 through the air outlet 44. The air impellers each manifest a maximum pressure difference between their inlets and outlets that they can maintain. By adjusting the speed of the air impeller the pressure exerted on the air stream being propelled through the apparatus can be varied.

By the incorporation of two or more air impellers in a series condition as represented in FIG. 3, the maximum pressure exerted on the air stream being propelled through the apparatus can be doubled or made even higher as necessary. This provides for the various filter and treatment elements such as 32, 34, 36, and 38 the ability to provide very restrictive flow characteristics but still maintain adequate air volume to pressurize the structure thereby providing a safe area and volume.

It is a preferred embodiment of the apparatus to provide for a wide and variable range of pressure flow through the apparatus.

It is also a preferred embodiment of the present invention to provide for the use of series or in-line air impellers, each separated by a pressure resistant wall, such as 41, for the purpose of providing a wide range of pressure production capability.

The air impellers 39 and 43 may also be equipped with the ability to be turned by human power through the addition of a crank and gear mechanism 46. This allows the apparatus to be partially operated even during the absence of electrical energy.

In the case where the apparatus is located entirely inside the safe area and volume, air outlet 44 may be constituted of a plurality of openings including grills, vents, pipes, ducts or other means of air conveyance. In the case where the apparatus is located completely outside the safe area and volume, air outlet 44 may be coupled to the safe area and volume by a plurality of air conveyance such as pipes, ducts, and other means of air conveyance.

It is a preferred embodiment of the present invention to provide for the integrity of the process of the apparatus by providing appropriate pressure differential between the inside of the apparatus and the outside of the apparatus so as to prevent contamination entering or exiting the apparatus through any openings in the shell or container of the apparatus.

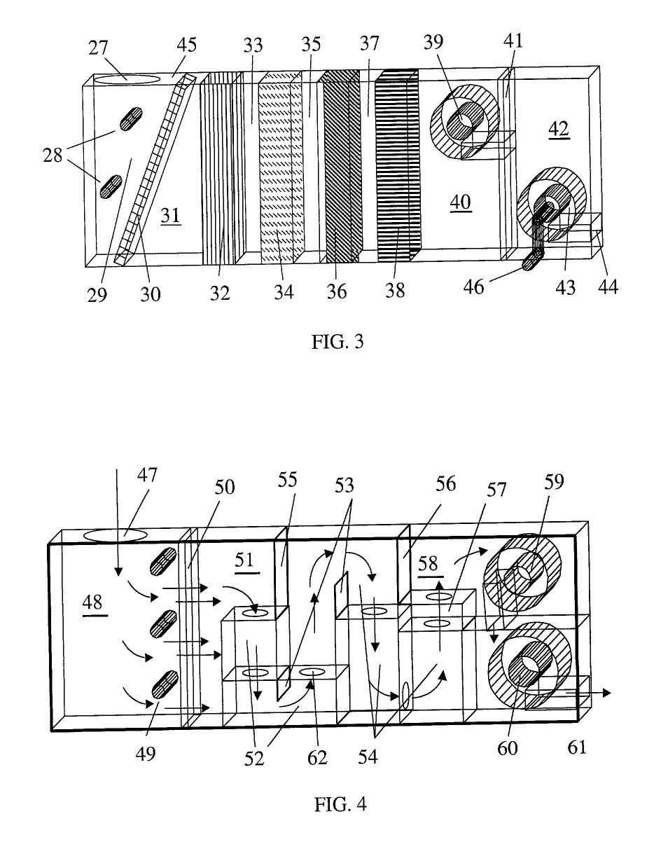

FIG. 4 illustrates another embodiment of the invention where the apparatus is folded internally in order to reduce the overall size without reducing the function or effectiveness of the design. Contaminated air is taken into the air intake 47 and moves into air space 48 where ultraviolet light from the multiplicity of ultraviolet bulbs 49 irradiate the incoming air and the surface of HEPA filter 50. Particles captured on HEPA filter 50 are irradiated for a prolonged period by ultraviolet bulbs 49 until the particles captured by the HEPA filter 50 are destructed and reduced in size such as to pass into the remaining process train of the apparatus. The contaminated air stream after passing through HEPA filter 50 enter airspace 51.

The contaminated air stream then passes through processes and chemical beds 52, 54 and 57, all being separated by intervening air spaces 62, and enter into airspace 58. Deflector restrictions 53 prevent the contaminated air stream from moving along the wall to circumvent the process and chemical beds and are a preferred embodiment of the present invention. The now clean and atmospherically normal and comfortable air is moved by air impellers and segregated spaces 59 and 60 through air outlet 61 into the safe area and volume of the structure.

In use, the apparatus can be activated when a harmful agent attack is detected, either automatically or manually. The apparatus may also be active at all times providing continuous protection and negating any effects from a biological or chemical attack. In the event of sustained or especially severe attack, or in the case of a highly virulent or infectious biological agent, the structure may be further sealed by the method herein provided to improve resistance to infiltration of the harmful agent.

It is a preferred embodiment of the present invention that the apparatus may also be active at all times providing continuous protection and negating any effects from a biological or chemical attack.

Sealing tape, such as aluminum, cellophane, duct and paper tape, can be used either alone or in combination with other materials such as sheet plastics or other nonporous covering material to seal openings into the structure such as windows, doors, lighting fixtures, electrical outlets, access panels, thermostats and other openings to the outside contaminated air as may exist in a particular structure.

Other penetrations such as plumbing and cable installations may be tightly stuffed with covering material, foam rubber, paper, aluminum foil or other suitable material and taped into place to prevent loosening. The use of expanding foams to seal penetrations in the structure is not recommended unless sufficient time is available to allow the foam to harden before the apparatus is required to be started. Uncured foams could be easily blown out if the apparatus is started before they are cured.

It is a preferred embodiment for rapidly adapting a structure wherein common wall electrical outlets are covered with a non-porous covering material such as a sheet of plastic or other non-conductive sheet material slightly larger than the cover plate, being secured to the wall with sealing tape on all sides.

It is a preferred embodiment for rapidly adapting a structure wherein cover plates are removed from common wall electrical outlets, a non-porous covering material such as a sheet of plastic or other non-conductive sheet material slightly larger than the cover plate is placed over the electrical outlet, and the cover plate is replaced. The screw or other fastener is pressed through the covering material to secure the cover plate in a normal manner. Electrical cables may be plugged into the outlet in a normal manner by simply pressing them through the cover material and into the wall outlet in a normal manner. In this manner, the airflow through the wall opening is greatly reduced. The flow may be further reduced by the addition of sealing tape around the exposed edge of the covering material.

It is a preferred embodiment of the present invention that all filters, chemical beds, and processes inherent and contained within the apparatus be separated by intervening air spaces such that the passage of the air stream out of one to another be controlled solely by the characteristics of each one individually and without regards for any contacting or joining of same.

While a particular embodiment of the present invention has been shown and described, it will be apparent to those skilled in the art that various changes and modifications may be made therein without departing from the spirit or scope of the invention. Numerous advantages of the invention covered by this document have been set forth in the foregoing description. It will be understood, however, that this disclosure is, in many respects, only illustrative. Changes may be made in details, particularly in matters of shape, size, and arrangement of parts without exceeding the scope of the invention. Accordingly, it is intended to cover all alternatives, modifications, and equivalents as may be included within the spirit and scope of the invention defined in the appended claims.

What I claim as my invention is:

1. An apparatus and method whereby a common structure such as a home or other building, or temporary structure such as a tent or manufactured housing, being equipped with one or more apparatus providing a supply of clean air thereby providing positive air pressure internal to the structure, said positive pressure being more than 0 pounds per square inch but less than 3 pounds per square inch causing an outflow of air from all structure openings, the structure thereby being converted into a suitable safe area for protecting humans, other living things, supplies, equipment and storage items from exposure to harmful airborne chemical and/or biological agents.

2. An apparatus as recited in claim 1, wherein said apparatus is comprised of both a positive pressure ventilator including an air impeller or pump of any kind combined with a decontaminator including filters and chemical reactant bed of any kind.

3. An apparatus as recited in claim 1, wherein said apparatus includes one or more contaminated air intake ducts and said intake duct has at least one end outside of said pressurized area of structure.

4. An apparatus as recited in claim 1, wherein said apparatus includes a process comprised of elements including a electrical plasma chemical and/or biological destructor and a filter/chemical reactant bed for the removal of the destructed chemical and/or destructed biological waste products.

5. An apparatus as recited in claim 1 wherein said apparatus includes a filter in which the capture surface is illuminated by ultraviolet light with a wavelength below 400 nanometers in wavelength for the purpose and process of further damaging and destructing particles captured on said filter through the action of the ultraviolet light.

6. An apparatus as recited in claim 1, wherein each filter, process and chemical reactant bed is separated one from the other by an intervening air space or material serving as an air space having permeability to the passing air stream that is much greater that the filter or chemical bed allowing the passing stream to enter the next filter or chemical bed in a manner consistent solely with the characteristics and permeability of that filter or chemical bed.

7. An apparatus as recited in claim 1, wherein a deflector is incorporated in the walls containing the filter and treatment chemicals in order that the air stream be forced to fully penetrate and have maximum interaction with said filter and chemicals.

8. An apparatus as recited in claim 1, wherein said apparatus includes a differential pressure sensor that signals the relative internal pressure of the structure to the outside air, said signal being provided to the apparatus for the wide range and variable regulation of the air impeller and/or bypass valve to maintain a positive internal relative pressure.

9. An apparatus as recited in claim 1, wherein the shell or enclosure of the apparatus not be required to be air tight in order to provide correct, safe and adequate intake, ducting, and decontaminating of the contaminated air.

10. An apparatus as recited in claim 1, wherein is provided for the use of series or in-line air impellers, each separated by a pressure resistant wall, for the purpose of providing a wide range of pressure and air stream flow regulation capability.

11. An apparatus as recited in claim 1, wherein the apparatus may be active at all times providing continuous protection and negating any effects from a biological or chemical attack.

12. An apparatus as recited in claim 1, wherein said apparatus incorporates the production of ozone gas and oxides of nitrogen as a reactant in the destruction of harmful biological and chemical agents.

13. An apparatus as recited in claim 1, wherein said filter/chemical reactant beds include calcium carbonate, marble, limestone and mixtures bearing these compounds.

14. An apparatus as recited in claim 1, wherein said filter/chemical reactant beds include activated carbon in any form including charcoal, granular, fibrous and coated onto a substrate.

15. An apparatus as recited in claim 1, wherein said apparatus is located inside the safe area and said apparatus is maintained at a negative internal pressure by means of the air pump drawing air through the apparatus, said negative internal pressure preventing the outflow of any of the harmful agent taken in with the outside air into the safe area.

16. An apparatus as recited in claim 1, wherein said apparatus is located outside the safe area and said apparatus is maintained at a positive internal pressure by means of the air pump forcing air through the apparatus, said positive internal pressure preventing the inflow of any of the harmful agent other than that intentionally taken in with the outside air, thereby preventing recontamination as the air is processed through the said apparatus.

17. An apparatus as recited in claim 1, wherein the HEPA filter is canted to provide more surface area thereby reducing the airflow velocity through the filter and increasing its ability to capture particulate.

18. A method whereby a common structure such as a home or other building, or temporary structure such as a survival shelter or manufactured housing, being equipped with one or more apparatus, creating a safe area for protecting humans, other living things, supplies, equipment and storage items from exposure to harmful airborne agent attack comprising the steps of;
providing means to intake outside air contaminated with harmful agents;
filtering out said harmful agent particles; removing and/or killing said agents;
removing said agent waste from the air;
purifying and rendering to a normal and comfortable status;
providing means to inject said decontaminated air into the structure under positive pressure thereby providing a safe area;
providing means for sealing said structure from the external atmosphere to increase positive pressurization of the structure;
sealing said structure from any external atmosphere using said sealing means;
and providing means to circulate and mix the newly injected air with air already inside the structure.

19. A method as recited in claim 18 for providing a decontaminated and normal atmosphere in a structure during a harmful agent attack comprising the steps of;
providing an apparatus;
providing sealing materials and method for sealing said common structure from the outside atmosphere to decrease leakage and increase internal pressurization;
and providing techniques for the sealing of a variety of openings.

20. A method as recited in claim 18, wherein said apparatus is supplied with electricity from an electrical source internal to the apparatus, internal to said structure, or external to said structure.

21. A method as recited in claim 18 where a kit for providing a decontaminated structure atmosphere is comprised of: one or more apparatus; sealing materials for sealing said common structure from the outside atmosphere to decrease leakage and increase internal pressurization; techniques for the sealing of a variety of common and non-specialized openings; and instructions for operation of the apparatus and use of the method.

22. A method as recited in claim 18, wherein said sealing materials are selected from the group consisting of;
sheet material suitable for windows and doors;
patches for the covering of wall electrical outlets;
aluminum and other sealing and structural tapes and patches; foam rubber; and paper.

23. A method as recited in claim 18 wherein common wall electrical outlets are covered with a non-porous covering material such as a sheet of plastic or other non-conductive sheet material slightly larger than the cover plate, being secured to the wall with sealing tape on all sides for the purpose of reducing or eliminating air flow into or out of the common structure.

24. A method as recited in claim 18 wherein cover plates are removed from common wall electrical outlets, a non-porous covering material such as a sheet of plastic or other non-conductive sheet material slightly larger than the cover plate is placed over the electrical outlet, and the cover plate is replaced with the screw or other fastener being pressed through the covering material to secure the cover plate in a normal manner.
